(19) United States
(12) Patent Application Publication
(10) Pub. No.: US 2007/0144374 A1
(43) Pub. Date: Jun. 28, 2007

(54) Register adjusting mechanism for split plate cylinder

(76) Inventors: Masakazu Namita, Fukuoka (JP); Shigehisa Saeki, Fukuoka (JP)

Correspondence Address: JORDAN AND HAMBURG LLP, 122 EAST 42ND STREET, SUITE 4000, NEW YORK, NY, 10168, US

(21) Appl. No.: 10/582,807

(22) PCT Filed: Nov. 30, 2004
(86) PCT No.: PCT/JP04/17811

§ 371 Date: Jul. 24, 2006

(30) Foreign Application Priority Data
Dec. 18, 2003 (JP) 2003-421471

(51) Int. Cl. B41F 13/24

(52) U.S. Cl. 101/248

(57) ABSTRACT

Disclosed is a register adjusting mechanism for a split plate cylinder, which comprises first and second axial register adjustment means C, D operable to axially move an operation-side plate cylinder 2 and a drive-side plate cylinder 1, respectively, so as to adjust an axial register thereof independently, and first and second circumferential register adjustment means A, B operable to circumferentially rotate the drive-side plate cylinder and the operation-side plate cylinder, respectively, so as to adjust a circumferential register thereof independently. The first and second axial register adjustment means C, D for the operation-side plate cylinder 2 and the drive-side plate cylinder 1 are disposed adjacent and connected to a journal 2b of the operation-side plate cylinder 2 and a journal 1c of the drive-side plate cylinder 1, respectively. At least one of the first and second circumferential register adjustment means A, B for the drive-side plate cylinder 1 and the operation-side plate cylinder 2 is disposed adjacent and connected to a journal 3b of a blanket cylinder 3. The register adjusting mechanism of the present invention makes it possible to prevent each of axial register adjustment means and circumferential register adjustment means from largely protruding from the split plate cylinder in an axial direction thereof so as to facilitate an assembling and maintenance operations of the split plate cylinder.

### TECHNICAL FIELD

The present invention relates to a rotary press having a printing unit provided with a split plate cylinder comprising a drive-side plate cylinder and an operation-side plate cylinder, and more specifically to a register adjusting mechanism for adjusting an axial and circumferential register of the split plate cylinder.

### BACKGROUND ART

As such a register adjusting mechanism for a split (or divided, segmented) plate cylinder, there has been known a plate cylinder assembly for a rotary printing press, as disclosed in the following Patent Publication 1. This plate cylinder assembly comprises a split plate cylinder consisting of a plate cylinder body and a shell cylinder fitted onto the plate cylinder body. The plate cylinder body has a drive-side journal portion (journal portion at one side of a rotary press where a drive mechanism, such as a spindle and a gearbox, is located) and an operation-side journal portion (journal portion at the other (opposite) side of the rotary press where an manual operating device, such as an operation panel and various operation buttons, is located). The drive-side journal portion is connected with an axial register adjustment device for adjusting an axial register of the plate cylinder body, and a circumferential register adjustment device for adjusting a circumferential register of the plate cylinder body. Further, the operation-side journal portion is connected with an axial register adjustment device for adjusting an axial register of the shell cylinder, and a circumferential register adjustment device for adjusting a circumferential register of the shell cylinder.

In the above assembly, the axial and circumferential register adjustment devices are disposed on both drive and operation sides relative to the split plate cylinder. This arrangement inevitably causes structural complexity on both sides of the split plate cylinder and complexity in assembling operation. Moreover, each of the adjustment devices largely protrudes from a support frame for the split plate cylinder to cause difficulty in installing the assembly or in adequately performing maintenance operations, if an installation space is quite restricted.

[Patent Publication 1] Japanese Patent Laid-Open Publication No. 10-202826

### DISCLOSURE OF THE INVENTION

In view of the above problems, it is an object of the present invention to provide a register adjusting mechanism for a split plate cylinder, capable of preventing each of axial register adjustment means and circumferential register adjustment means from largely protruding from the split plate cylinder in an axial direction thereof so as to facilitate assembling and maintenance operations of the split plate cylinder.

In order to achieve the above object, the present invention provides a register adjusting mechanism for a split plate cylinder provided in a printing unit of a rotary press. The printing unit includes a blanket cylinder disposed in contact with the split plate cylinder, and the split plate cylinder comprises a drive-side plate cylinder and an operation-side plate cylinder each supported in an axially movable and circumferentially rotatable manner. The register adjusting mechanism comprises: first and second axial register adjustment means operable to axially move the operation-side plate cylinder and the drive-side plate cylinder, respectively, so as to adjust an axial register thereof independently; and first and second circumferential register adjustment means operable to circumferentially rotate the drive-side plate cylinder and the operation-side plate cylinder, respectively, so as to adjust a circumferential register thereof independently. In register adjusting mechanism, the first axial register adjustment means for the operation-side plate cylinder and the second axial register adjustment means for the drive-side plate cylinder are disposed adjacent and connected to a journal of the operation-side plate cylinder and a journal of the drive-side plate cylinder, respectively. Further, at least one of the first and second circumferential register adjustment means for the drive-side plate cylinder and the operation-side plate cylinder is disposed adjacent and connected to a journal of the blanket cylinder.

In one preferred embodiment of the present invention, when the drive-side plate cylinder of the split plate cylinder has a core portion fitted into a hollow cylinder portion of the operation-side plate cylinder, and an operation-side journal portion inserted into an operation-side journal portion of the operation-side plate cylinder to extend outside the operation-side journal portion of the operation-side plate cylinder, the first axial register adjustment means for the operation-side plate cylinder is disposed adjacent and connected to the operation-side journal portion of the operation-side plate cylinder, and the second axial register adjustment means for the drive-side plate cylinder is disposed adjacent and connected to the operation-side journal portion of the drive-side plate cylinder. Further, the first circumferential register adjustment means for the drive-side plate cylinder is disposed adjacent and connected to a drive-side journal portion of the drive-side plate cylinder, and the second circumferential register adjustment means for the operation-side plate cylinder is disposed adjacent and connected to an operation-side journal portion of the blanket cylinder.

When the operation-side journal portion of the drive-side plate cylinder is not designed to extend outside the operation-side journal portion of the operation-side plate cylinder, the second axial register adjustment means for the drive-side plate cylinder may be disposed adjacent and connected to the drive-side journal portion of the drive-side plate cylinder.

In one preferred embodiment of the present invention, the at least one of the first and second circumferential register adjustment means which is connected to the journal of the blanket cylinder includes a gear member which has an outer peripheral surface provided with a spur gear, and an inner peripheral surface provided with an internal helical gear. The spur gear of the gear member is engaged with a spur gear provided in either one of the journals of the drive-side plate cylinder and the operation-side plate cylinder, and the internal helical gear of the gear member is engaged with an external helical gear provided in the journal of the blanket cylinder.

As above, in the register adjusting mechanism of the present invention, at least one of the first and second circumferential register adjustment means for the drive-side plate cylinder and the operation-side plate cylinder is disposed adjacent and connected to the journal of the blanket cylinder. Thus, while a space on the side of the journal of the blanket cylinder has been left as a dead space in the conventional mechanism, this arrangement makes it possible to effectively utilize such a space as an installation space for the circumferential register adjustment means, so as to allow an axial protrusion of the split plate cylinder to be reduced without the need for additional installation space. In addition, this arrangement makes it possible to facilitate the assembling and maintenance operations of the split plate cylinder.

### BRIEF DESCRIPTION OF DRAWINGS

FIG. 1 is a conceptual diagram showing a fundamental arrangement of a register adjustment mechanism for a split plate cylinder, according to a first embodiment of the present invention.

FIG. 2 is a vertical sectional view showing the structure of first circumferential register adjustment means for a drive-side plate cylinder, in the register adjustment mechanism according to the first embodiment.

FIG. 3 is a vertical sectional view showing the structure of second circumferential register adjustment means for an operation-side plate cylinder, in the register adjustment mechanism according to the first embodiment.

FIG. 4 is a vertical sectional view showing respective structures of first axial register adjustment means for the operation-side plate cylinder, and second axial register adjustment means for the drive-side plate cylinder, in the register adjustment mechanism according to the first embodiment.

FIG. 5 is a conceptual diagram showing a fundamental arrangement of a register adjustment mechanism for a split plate cylinder, according to a second embodiment of the present invention.

FIG. 6 is a vertical sectional view showing the structure of second axial register adjustment means for a drive-side plate cylinder, in the register adjustment mechanism according to the second embodiment.

### BEST MODE FOR CARRYING OUT THE INVENTION

With reference to the drawings, the present invention will now be described based on an illustrated embodiment thereof.

### First Embodiment

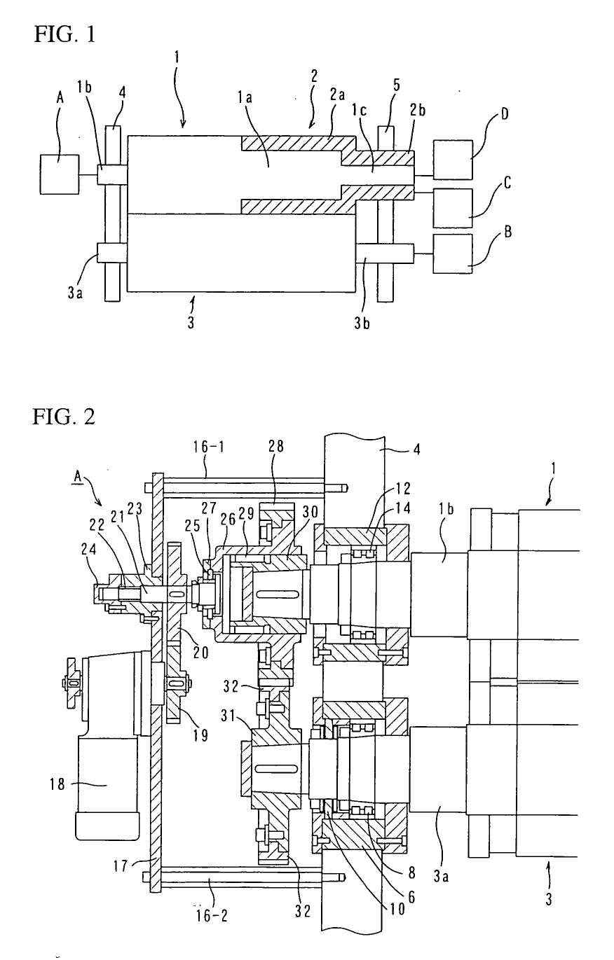

FIG. 1 is a conceptual diagram showing a fundamental arrangement of a register adjustment mechanism for a split plate cylinder, according to a first embodiment of the present invention. As shown in FIG. 1, the split plate cylinder comprises a drive-side plate cylinder 1 and an operation-side plate cylinder 2. The split plate cylinder is integrated by fitting a core portion 1a of the drive-side plate cylinder 1 into a hollow cylinder portion 2a of the operation-side plate cylinder 2. A blanket cylinder 3 is disposed to be in contact with a plate or lithographic plate (not shown) attached onto the respective outer peripheral surfaces of the drive-side plate cylinder 1 and the operation-side plate cylinder 2.

Each of the drive-side plate cylinder 1 and the operation-side plate cylinder 2 is supported by a drive-side frame 4 and an operation-side frame 5, in a circumferentially rotatable and axially movable manner and in a finely adjustable manner.

The blanket cylinder 3 is supported by a drive-side frame 4 and an operation-side frame 5, in a circumferentially rotatable and axially immovable manner.

As the register adjustment mechanism, first circumferential register adjustment means A is disposed adjacent and connected to a drive-side journal portion 1b of the drive-side plate cylinder 1 to rotate the drive-side plate cylinder 1 in a circumferential direction thereof so as to adjust a circumferential register of the drive-side plate cylinder 1. In order to rotate the operation-side plate cylinder 2 in a circumferential direction thereof so as to adjust a circumferential register of the operation-side plate cylinder 2, second circumferential register adjustment means B is disposed adjacent and connected to an operation-side journal portion 3b of the blanket cylinder 3, instead of the operation-side plate cylinder 2 as in the aforementioned conventional mechanism.

Further, first axial register adjustment means C is disposed adjacent and connected to an operation-side hollow journal portion 2b of the operation-side plate cylinder 2 to move the operation-side plate cylinder 2 in an axial direction thereof so as to adjust an axial register of the operation-side plate cylinder 2. The drive-side plate cylinder 1 has an operation-side journal portion 1c extending outside the operation-side hollow journal portion 2b of the operation-side plate cylinder 2, and second axial register adjustment means D is disposed adjacent and connected to the operation-side journal portion 1c of the drive-side plate cylinder 1 to move the drive-side plate cylinder 1 in an axial direction thereof so as to adjust an axial register of the drive-side plate cylinder 1.

Respective structures of the first circumferential register adjustment means A for the drive-side plate cylinder 1, the second circumferential register adjustment means B for the operation-side plate cylinder 1, the first axial register adjustment means C for the operation-side plate cylinder 2, and the second axial register adjustment means D for the drive-side plate cylinder 1, will be described below.

[I. First Circumferential Register Adjustment Means for Drive-Side Plate Cylinder]

FIG. 2 is a vertical sectional view showing the structure of the first circumferential register adjustment means for the drive-side plate cylinder. As shown in FIG. 2, a geared motor 18 for adjusting a circumferential register of the drive-side plate cylinder 1 is fixed on a base plate 17 mounted to a plurality of support rods 16-1, 16-2 threadingly fastened to a drive-side frame 4, and a spur gear 19 is fixed to an end of a driving shaft of the geared motor 18. The spur gear 19 is engaged with a spur gear 20 fixed to a movable shaft 21 disposed concentrically with the drive-side plate cylinder 1. This movable shaft 21 is formed with a threaded portion 22, and a bracket 23 fixed to the base plate 17 is engaged with the threaded portion 22 to support the movable shaft 21. Another bracket 24 is fixed to the bracket 23 to support a distal end of the movable shaft 21. The other end of the movable shaft 21 is provided with a thrust bearing 25 having a center ring supported by a gear boss 26 and a flange 27.

The gear boss 26 has an outer peripheral surface having a helical gear 28 attached thereon, and an inner peripheral surface formed as an internal spur gear 29. This internal spur gear 29 is engaged with an external spur gear 30 along an entire circumference thereof. The external spur gear 30 is fixed onto the drive-side journal portion 1b of the drive-side plate cylinder 1. The helical gear 28 is engaged with another helical gear 32 mounted on a gear boss 31 fixed to a drive-side journal portion 3a of the blanket cylinder 3.

In FIG. 2, the reference numeral 6 indicates an eccentric sleeve supporting the drive-side journal portion 3a of the blanket cylinder 3, and the reference numeral 8 indicates a cylindrical roller bearing fixed onto an inner peripheral surface of the eccentric sleeve 6. The reference numeral 10 indicates a thrust bearing fixed onto the inner peripheral surface of the eccentric sleeve 6, and the reference numeral 12 indicates a sleeve supporting the drive-side journal portion 1b of the drive-side plate cylinder 1. The reference numeral 14 indicates a cylindrical roller bearing fixed onto an inner peripheral surface of the sleeve 12.

In the above structure, when a monitoring device (not shown) detects a displacement of the drive-side plate cylinder 1 in a feed direction of a web, i.e. in a circumferential direction of the drive-side plate cylinder 1, during printing operation, the monitoring device converts the detected displacement to an electric signal, and sends the electric signal to the geared motor 18. In response to receiving the electric signal, the geared motor 18 rotates the driving shaft thereof at an angle corresponding to the displacement to rotate the circumferential register adjusting spur gears 19, 20. Thus, the movable shaft 21 is rotated and moved in the axial direction by the action of the threaded portion 22. During the rotation and axial movement, the thrust bearing 25 at the end of the movable shaft 21 transmits only the axial movement to the gear boss 26 and the flange 27. The inner peripheral surface of the gear boss 26 is formed as the internal spur gear 29 engaged with the external spur gear 30 fixed to the drive-side journal portion 1b of the drive-side plate cylinder 1. Thus, even if the gear boss 26 is axially moved, the external spur gear 30 of the drive-side journal portion 1b of the drive-side plate cylinder 1 is not axially moved. The outer peripheral surface of the gear boss 26 has the helical gear 28 fixed thereon, and the helical gear 28 is engaged with the helical gear 32 fixed to the blanket cylinder 3. Thus, in proportion to a helical angle of the helical gear 28 resulting from the axial movement of the gear boss 26, all of the helical gear 28, the gear boss 26, the external spur gear 30 and the drive-side plate cylinder 1 are integrally rotated in the circumferential direction relative to the blanket cylinder 3, to correct the circumferential displacement of the drive-side plate cylinder.

[II. Second Circumferential Register Adjustment Means for Operation-Side Plate Cylinder]

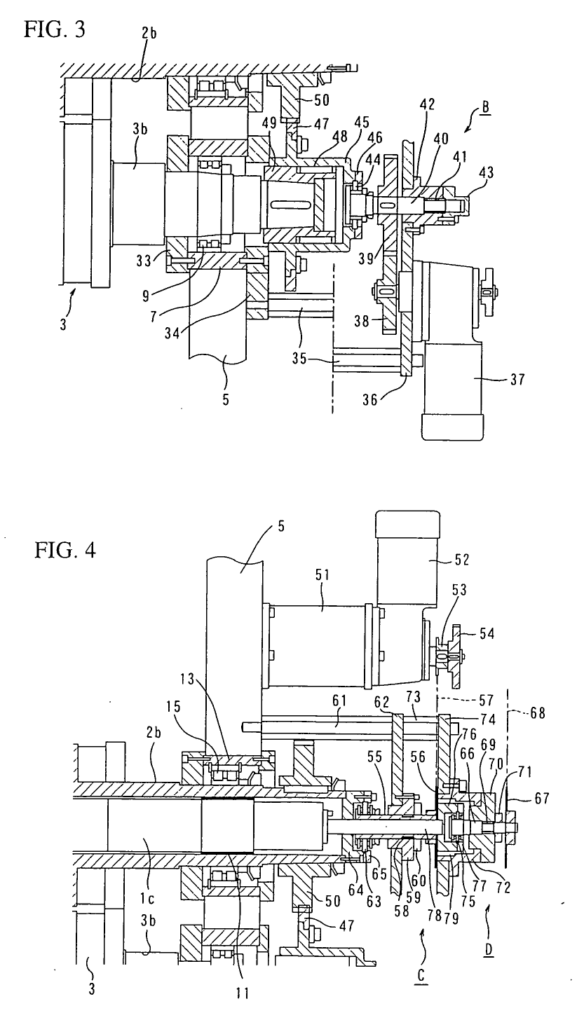

FIG. 3 is a vertical sectional view showing the structure of the second circumferential register adjustment means for the operation-side plate cylinder. As shown in FIG. 3, a concentric sleeve 7 supporting the operation-side journal portion 3b of the blanket cylinder 3 has a pair of side flanges 33, 34 fixed to respective opposite side surfaces thereof, and a plurality of support rods 35 are threadingly fixed to the side flange 34. A base plate 36 is fixed to the support rods 35, and a geared motor 37 is mounted onto the base plate 36 to adjust a circumferential register of the operation-side plate cylinder 2. A spur gear 38 is fixed to an end of a driving shaft of the geared motor 37. The spur gear 38 is engaged with another spur gear 39 fixed onto a movable shaft 40 disposed concentrically with the blanket cylinder 3. The movable shaft 40 is formed with a threaded portion 41, and a bracket 42 fixed to the base plate 36 is engaged with the threaded portion 41 to support the movable shaft 40. Another bracket 43 is fixed to the bracket 43 to support a distal end of the movable shaft 40. The other end of the movable shaft 40 is provided with a thrust bearing 44 having a center ring supported by a gear boss 45 and a flange 46.

The gear boss 45 has an outer peripheral surface having a spur gear 47 attached thereon, and an inner peripheral surface having an internal helical gear 48 machined therein. This internal spur gear 49 is engaged with an external helical gear 49 along an entire circumference thereof. The external helical gear 49 is fixed onto the operation-side journal portion 3b of the blanket cylinder 3. The spur gear 47 is engaged with another spur gear 50 fixed onto the operation-side journal portion 2b of the operation-side plate cylinder 2.

In FIG. 3, the reference numeral 9 indicates a cylindrical roller bearing fixed onto an inner peripheral surface of the eccentric sleeve 7.

In the above structure, when a monitoring device (not shown) detects a displacement of the operation-side plate cylinder 2 in a feed direction of a web, i.e. in a circumferential direction of the operation-side plate cylinder 2, during printing operation, the monitoring device converts the detected displacement to an electric signal, and sends the electric signal to the circumferential register adjusting geared motor 37. In response to receiving the electric signal, the circumferential register adjusting geared motor 37 rotates the driving shaft thereof at an angle corresponding to the displacement to rotate the spur gears 38, 39. Thus, the movable shaft 40 is rotated and moved in the axial direction by the action of the threaded portion 41. During the rotation and axial movement, the thrust bearing 44 at the end of the movable shaft 40 transmits only the axial movement to the gear boss 45 and the flange 46. The inner peripheral surface of the gear boss 45 has the internal helical gear 48 engaged with the external helical gear 49 fixed to the operation-side journal portion 3b of the blanket cylinder 3. Thus, when the gear boss 45 is axially moved, the gear boss 45 and the spur gear 47 are circumferentially rotated relative to the blanket cylinder 3, in proportion to a helical angle of the internal helical gear 48 and the external helical gear 49. In conjunction with this rotation, the spur gear 50 fixed to the operation-side journal portion 2b of the operation-side plate cylinder 2 engaged with the spur gear 47 is rotated at a corresponding angle, so as to correct the circumferential displacement of the operation-side plate cylinder.

[III. First Axial Register Adjustment Means for Operation-Side Plate Cylinder]

FIG. 4 is a vertical sectional view showing respective structures of the first axial register adjustment means C for the operation-side plate cylinder and the second axial register adjustment means D for the drive-side plate cylinder.

Firstly, the first axial register adjustment means C will be described below. As shown in FIG. 4, a motor mount 51 is attached to an operation-side frame 5 at a given position, and a geared motor 52 is mounted onto the motor mount 51 to adjust an axial register of the operation-side plate cylinder 2. A chain sprocket 53 and a spur gear 54 are fixed onto a driving shaft of the geared motor 52. The spur gear 54 is engaged with a spur gear fixed to a shaft of an encoder (not shown).

Through a chain 57, the chain sprocket 53 is connected to a chain sprocket 56 fixed to one end of a hollow movable shaft 55 disposed concentrically with the drive-side plate cylinder 1 and the operation-side plate cylinder 2. The hollow movable shaft 55 has an outer peripheral surface formed with a threaded portion 58. This threaded portion 58 is engaged with a bracket 59 and a flange 60 which are fixed to a base plate 62 to support the hollow movable shaft 55. The base plate 62 is mounted to a plurality of support rods 61 threadingly fixed to the operation-side frame 5. The other end of the hollow movable shaft 55 is provided with a thrust bearing 63 having a center ring supported by a connection flange 64 and a flange 65. The flange 65 is fixed to the connection flange 64. The connection flange 64 is fixed onto an end surface of the operation-side journal portion 2b of the operation-side plate cylinder 2.

In FIG. 4, the reference numeral 11 indicates a plane bearing interposed between the operation-side journal portion 1c of the drive-side plate cylinder 1 and the hollow operation-side journal portion 2b of the operation-side plate cylinder 2, and the reference numeral 13 indicates a sleeve supporting the hollow operation-side journal portion 2b of the operation-side plate cylinder 2. The reference numeral 15 indicates a cylindrical roller bearing fixed onto an inner peripheral surface of the sleeve 13.

In the above structure, when a monitoring device (not shown) detects a displacement of the operation-side plate cylinder 2 in a width direction of a web, i.e. in an axial direction of the operation-side plate cylinder 2, during printing operation, the monitoring device converts the detected displacement to an electric signal, and sends the electric signal to the axial register adjusting geared motor 52. In response to receiving the electric signal, the axial register adjusting geared motor 52 rotates the driving shaft thereof at an angle corresponding to the displacement to rotate the chain sprockets 53, 56. Thus, the hollow movable shaft 55 is rotated and moved in the axial direction by the action of the threaded portion 58. During the rotation and axial movement, the thrust bearing 63 at the end of the hollow movable shaft 55 transmits only the axial movement to the operation-side plate cylinder 2 integrated with the connection flange 64 and the flange 65. The gear 50 fixed to the operation-side journal portion 2b of the operation-side plate cylinder 2 is a spur gear, and the gear 47 of the blanket cylinder 3 engaged with the spur gear 47 is also a spur gear. Thus, even if the operation-side plate cylinder 2 is axially moved, a circumferential phase of the operation-side plate cylinder 2 relative to the blanket cylinder 3 will not be changed. Therefore, the operation-side plate cylinder 2 is moved only in the axial direction, so as to correct the axial displacement of the operation-side plate cylinder.

[IV. Second Axial Register Adjustment Means for Drive-Side Plate Cylinder]

Although not illustrated in FIG. 4, a geared motor for adjusting an axial register of the drive-side plate cylinder 1 is mounted onto a motor mount at a given position of the operation-side frame 5, and a set of a chain sprocket and a spur gear is fixed onto a driving shaft of this geared motor. Except for a height dimension of the motor mount, these components are the same as the respective components 51 to 54 in the first axial register adjustment means C.

Through a chain 68, the chain sprocket (not shown) on the driving shaft of the axial register adjusting geared motor (not shown) is connected to a chain sprocket 67 fixed to one end of a movable shaft 66 disposed concentrically with the drive-side plate cylinder 1 and the operation-side plate cylinder 2. The movable shaft 66 is formed with a threaded portion 69. This threaded portion 69 is engaged with a bracket 70 and a flange 71 which are fixed to an outer base plate 74 through a sleeve 72 to support the movable shaft 66. The outer base plate 74 is mounted to a plurality of support rods 73 threadingly fixed to the base plate 62. The other end of the movable shaft 66 is provided with a thrust bearing 75 having a center ring supported by a connection flange 76 and a flange 77. The flange 77 is fixed to the connection flange 76. The connection flange 76 is fixed to an elongated connection shaft 78 fixed to the operation-side journal portion 1c of the drive-side plate cylinder 1, in such a manner as to be rotated together with the operation-side journal portion 1c of the drive-side plate cylinder 1 on a constant basis. For this purpose, a needle bearing 79 is interposed between the connection flange 76 and the sleeve 72 fixed to the outer base plate 74, to maintain a rotatable state of the connection flange 76, and allow the elongated connection shaft 78 and the drive-side plate cylinder 1 to be moved axially and integrally.

In the above structure, when a monitoring device (not shown) detects a displacement of the drive-side plate cylinder 1 in a width direction of a web, i.e. in an axial direction of the drive-side plate cylinder 1, during printing operation, the monitoring device converts the detected displacement to an electric signal, and sends the electric signal to the axial register adjusting geared motor. In response to receiving the electric signal, the axial register adjusting geared motor rotates the driving shaft thereof at an angle corresponding to the displacement to rotate the chain sprocket 67. Thus, the movable shaft 66 is rotated and moved in the axial direction by the action of the threaded portion 69. During the rotation and axial movement, the thrust bearing 75 at the end of the movable shaft 66 transmits only the axial movement to the drive-side plate cylinder 1 through the elongated connection shaft 78 integrated with the connection flange 76 and the flange 77. While the drive-side plate cylinder 1 is axially moved, the gear boss 26 and the helical gear 28 are not axially moved, because the internal spur gear 29 is engaged with the external spur gear 30 fixed to the drive-side journal portion 1b, as described in connection with FIG. 2. Thus, even if the drive-side plate cylinder 1 is axially moved, a circumferential phase of the drive-side plate cylinder 1 relative to the blanket cylinder 3 will not be changed. Therefore, the drive-side plate cylinder 1 is moved only in the axial direction, so as to correct the axial displacement of the drive-side plate cylinder.

As described above, in the register adjusting mechanism according to the above embodiment, an axial and circumferential register of the drive-side and operation side plate cylinders can be adjusted by the first circumferential register adjustment means A, the second circumferential register adjustment means B, the first axial register adjustment means C and the second axial register adjustment means D. Further, while a space on the side of the operation-side journal portion 3b of the blanket cylinder 3 has been left as a dead space in the conventional mechanism, the register adjusting mechanism according to the above embodiment makes it possible to effectively utilize the space for installing the second circumferential register adjustment means B, so as to reduce an axial protrusion of the split plate cylinder to minimize an installation space. In addition, the structure of the split plate cylinder can be simplified in the axial direction so as to facilitate the assembling and maintenance operations of the split plate cylinder.

### Second Embodiment

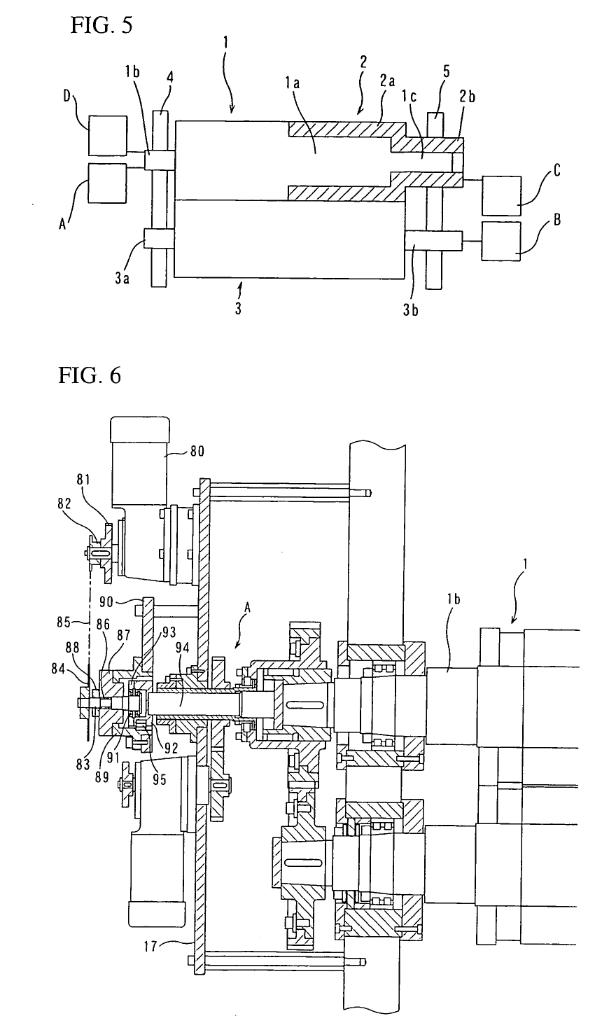

FIG. 5 is a conceptual diagram showing a fundamental arrangement of a register adjustment mechanism for a split plate cylinder, according to a second embodiment of the present invention. In the first embodiment, the split plate cylinder is designed to extend the operation-side journal portion 1c of the drive-side plate cylinder 1, outside the operation-side journal portion 2b of the operation-side plate cylinder 2, and the second axial register adjustment means D is disposed adjacent and connected to the operation-side journal portion 1c of the drive-side plate cylinder 1. In the second embodiment, without extending the operation-side journal portion 1c outside the operation-side journal portion 2b, the second axial register adjustment means D is disposed adjacent and connected to the drive-side journal portion 1b of the drive-side plate cylinder 1. In the second embodiment, respective structures of first circumferential register adjustment means A, second circumferential register adjustment means B and first axial register adjustment means C are the same as those in the first embodiment, and their description will be omitted.

FIG. 6 is a sectional view showing the structure of the second axial register adjustment means D for the drive-side plate cylinder.

As shown in FIG. 6, a geared motor 80 is mounted onto the drive-side base plate 17 to adjust an axial register of the drive-side plate cylinder 1, and a spur gear 81 and a chain sprocket 82 are fixed onto a driving shaft of the geared motor 80. The spur gear 81 is engaged with a spur gear fixed to a shaft of an encoder (not shown).

Through a chain 85, the chain sprocket 82 is connected to a chain sprocket 84 fixed to one end of a movable shaft 83 disposed concentrically with the drive-side plate cylinder 1 and the operation-side plate cylinder 2. The movable shaft 83 is formed with a threaded portion 86. This threaded portion 86 is engaged with a bracket 87 and a flange 88 which are fixed to an outer base plate 90 through a sleeve 89 to support the movable shaft 83. The outer base plate 90 is threadingly fixed to the base plate 17. The other end of the movable shaft 83 is provided with a thrust bearing 91 having a center ring supported by a connection flange 92 and a flange 93. The flange 93 is fixed to the connection flange 92. The connection flange 92 is fixed to an elongated connection shaft 94 fixed to the drive-side journal portion 1b of the drive-side plate cylinder 1, in such a manner as to be rotated together with the drive-side journal portion 1b of the drive-side plate cylinder 1 on a constant basis. For this purpose, a needle bearing 95 is interposed between the connection flange 92 and the sleeve 89 fixed to the outer base plate 90, to maintain a rotatable state of the connection flange 92, and allow the elongated connection shaft 94 and the drive-side plate cylinder 1 to be moved axially and integrally.

In the above structure, when a monitoring device (not shown) detects a displacement of the drive-side plate cylinder 1 in a width direction of a web, i.e. in an axial direction of the drive-side plate cylinder 1, during printing operation, the monitoring device converts the detected displacement to an electric signal, and sends the electric signal to the axial register adjusting geared motor 80. In response to receiving the electric signal, the axial register adjusting geared motor 80 rotates the driving shaft thereof at an angle corresponding to the displacement to rotate the chain sprockets 82, 84. Thus, the movable shaft 83 is rotated and moved in the axial direction by the action of the threaded portion 86. During the rotation and axial movement, the thrust bearing 91 at the end of the movable shaft 83 transmits only the axial movement to the drive-side plate cylinder 1 through the elongated connection shaft 94 integrated with the connection flange 92 and the flange 93. While the drive-side plate cylinder 1 is axially moved, the gear boss 26 and the helical gear 28 are not axially moved, because the internal spur gear 29 is engaged with the external spur gear 30 fixed to the drive-side journal portion 1b, as described in connection with FIG. 2. Thus, even if the drive-side plate cylinder 1 is axially moved, a circumferential phase of the drive-side plate cylinder 1 relative to the blanket cylinder 3 will not be changed. Therefore, the drive-side plate cylinder 1 is moved only in the axial direction, so as to correct the axial displacement of the drive-side plate cylinder.

The first circumferential register adjustment means A disposed on the side of the drive-side journal portion 1b of the drive-side plate cylinder 1 has the same structure as that in the first embodiment, and its description will be omitted.

### INDUSTRIAL APPLICABILITY

The present invention is usable as a register adjusting mechanism in a printing unit of a rotary press provided with a split plate cylinder comprising a drive-side plate cylinder and an operation-side plate cylinder.

What is claimed is:

1. A register adjusting mechanism for a split plate cylinder provided in a printing unit of a rotary press, said printing unit including a blanket cylinder disposed in contact with said split plate cylinder, said split plate cylinder comprising a drive-side plate cylinder and an operation-side plate cylinder each supported in an axially movable and circumferentially rotatable manner, said register adjusting mechanism comprising:
first and second axial register adjustment means operable to axially move said operation-side plate cylinder and said drive-side plate cylinder, respectively, so as to adjust an axial register thereof independently; and
first and second circumferential register adjustment means operable to circumferentially rotate said drive-side plate cylinder and said operation-side plate cylinder, respectively, so as to adjust a circumferential register thereof independently,
wherein:
said first axial register adjustment means for said operation-side plate cylinder and said second axial register adjustment means for said drive-side plate cylinder are disposed adjacent and connected to a journal of said operation-side plate cylinder and a journal of said drive-side plate cylinder, respectively; and
at least one of said first and second circumferential register adjustment means for said drive-side plate cylinder and said operation-side plate cylinder is disposed adjacent and connected to a journal of said blanket cylinder.

2. The register adjusting mechanism as defined in claim 1, wherein said drive-side plate cylinder of said split plate cylinder has a core portion fitted into a hollow cylinder portion of said operation-side plate cylinder, and an operation-side journal portion inserted into an operation-side journal portion of said operation-side plate cylinder to extend outside said operation-side journal portion of said operation-side plate cylinder, wherein:
said first axial register adjustment means for said operation-side plate cylinder is disposed adjacent and connected to the operation-side journal portion of said operation-side plate cylinder;
said second axial register adjustment means for said drive-side plate cylinder is disposed adjacent and connected to the operation-side journal portion of said drive-side plate cylinder;
said first circumferential register adjustment means for said drive-side plate cylinder is disposed adjacent and connected to a drive-side journal portion of said drive-side plate cylinder; and
said second circumferential register adjustment means for said operation-side plate cylinder is disposed adjacent and connected to an operation-side journal portion of said blanket cylinder.

3. The register adjusting mechanism as defined in claim 1, wherein said drive-side plate cylinder of said split plate cylinder has a core portion fitted into a hollow cylinder portion of said operation-side plate cylinder, wherein:
said first axial register adjustment means for said operation-side plate cylinder is disposed adjacent and connected to an operation-side journal portion of said operation-side plate cylinder;
said second axial register adjustment means for said drive-side plate cylinder is disposed adjacent and connected to a drive-side journal portion of said drive-side plate cylinder;
said first circumferential register adjustment means for said drive-side plate cylinder is disposed adjacent and connected to a drive-side journal portion of said drive-side plate cylinder; and
said second circumferential register adjustment means for said operation-side plate cylinder is disposed adjacent and connected to an operation-side journal portion of said blanket cylinder.

4. The register adjusting mechanism as defined in either one of claims 1 to 3, wherein:
said at least one of said first and second circumferential register adjustment means which is connected to the journal of said blanket cylinder includes a gear member which has an outer peripheral surface provided with a spur gear, and an inner peripheral surface provided with an internal helical gear, wherein:
said spur gear of said gear member is engaged with a spur gear provided in either one of the journals of said drive-side plate cylinder and said operation-side plate cylinder; and
said internal helical gear of said gear member is engaged with an external helical gear provided in the journal of said blanket cylinder.
